(19) United States
(12) Patent Application Publication
(10) Pub. No.: US 2018/0225325 A1
(43) Pub. Date: Aug. 9, 2018

(54) APPLICATION RESILIENCY MANAGEMENT USING A DATABASE DRIVER

(71) Applicant: International Business Machines Corporation, Armonk, NY (US)

(72) Inventors: Sujan S. Ghosh, Bangalore (IN); Vinayak Joshi, Bangalore (IN); Amitava Kundu, Bangalore (IN); Shilu Mathai, Bangalore (IN)

(21) Appl. No.: 15/427,028

(22) Filed: Feb. 7, 2017

(51) Int. Cl. G06F 17/30; G06F 9/50

(52) U.S. Cl. CPC G06F 17/30377; G06F 9/5055; G06F 17/30463

(57) ABSTRACT

Disclosed aspects relate to using a database driver to manage application resiliency with respect to a shared pool of configurable computing resources. A transaction request having a set of command data may be received. An updated set of global property data for the database driver may be detected. The updated set of global property data for the database driver may be captured in a memory device coupled with the database driver. An operational member asset of the shared pool of configurable computing resources may be determined to process the transaction request. The transaction request may be connected with the operational member asset of the shared pool of configurable computing resources. The set of command data for the transaction request may be transmitted to the operational member of the shared pool of configurable computing resources.

### BACKGROUND

This disclosure relates generally to computer systems and, more particularly, relates to using a database driver to manage application resiliency with respect to a shared pool of configurable computing resources. Databases are used to store information for numerous types of applications. Database management systems (DBMSs) are a typical mechanism for accessing data stored in a database. DBMSs often require tremendous resources to handle the heavy workloads placed on such systems. As such, it may be useful to increase the performance of database management systems with respect to processing searches, or queries, to databases.

### SUMMARY

Aspects of the disclosure relate to managing application resiliency in a cluster environment by dynamically updating alternate server information. Automatic client reroute (ACR) may provide high availability in a cluster environment. A database connection that suffers an outage may be recovered by being rerouted to an alternate server on a continual basis. When an asset or member fails, connections to the failed asset may be rerouted to any other available members in the shared pool of configurable computing resources. The application may re-execute the connection using an ACR algorithm. Application work may continue uninterrupted while the failed asset may be recovered.

Disclosed aspects relate to using a database driver to manage application resiliency with respect to a shared pool of configurable computing resources. A transaction request having a set of command data may be received. An updated set of global property data for the database driver may be detected. The updated set of global property data for the database driver may be captured in a memory device coupled with the database driver. An operational member asset of the shared pool of configurable computing resources may be determined to process the transaction request. The transaction request may be connected with the operational member asset of the shared pool of configurable computing resources. The set of command data for the transaction request may be transmitted to the operational member of the shared pool of configurable computing resources.

The above summary is not intended to describe each illustrated embodiment or every implementation of the present disclosure.

### BRIEF DESCRIPTION OF THE SEVERAL VIEWS OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a cloud computing node according to embodiments.

FIG. 2 depicts a cloud computing environment according to embodiments.

FIG. 3 depicts abstraction model layers according to embodiments.

FIG. 4 illustrates an example representation of a computer system connected to a client computer via a network according to embodiments.

FIG. 5 illustrates an example database management system (DBMS) according to embodiments.

FIG. 6 is a flowchart illustrating a method of using a database driver to manage application resiliency, according to embodiments.

FIG. 7 is a flowchart illustrating a method of using a database driver to manage application resiliency, according to embodiments.

FIG. 8 is a flowchart illustrating a method of using a database driver to manage application resiliency, according to embodiments.

FIG. 9 is a flowchart illustrating a method of using a database driver to manage application resiliency, according to embodiments.

FIG. 10 shows an example system for using a database driver to manage application resiliency, according to embodiments.

FIG. 11 shows an example system for using a database driver to manage application resiliency, according to embodiments.

FIG. 12 shows an example system for using a database driver to manage application resiliency, according to embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the disclosure relate to managing application resiliency in a cluster environment by dynamically updating alternate server information. Automatic client reroute (ACR) may provide high availability in a cluster environment. A database connection that suffers an outage may be recovered by being rerouted to an alternate server on a continual basis. When an asset or member fails, connections to the failed asset may be rerouted to any other available members in the shared pool of configurable computing resources. The application may re-execute the connection using an ACR algorithm. Application work may continue uninterrupted while the failed asset may be recovered.

Applications may be run in a production environment against clusters. During the application execution, a planned maintenance activity or outage (e.g., server side) may result in one of the members of the target cluster being removed from an ordered list of members, adding a new member to the ordered list, or changing the order of the members of the ordered list. This may occur dynamically in order to direct connection requests from the application to a new member without impacting the client application resiliency. The server may communicate the maintenance activities or outage information to the client (in a static way) and the client application code may be altered. This may impact customer real-time production systems. Communication of outage information and the alteration of the client application code dynamically may have positive impacts with respect to failover of connections to other members of the ordered list. Aspects described herein may update the alternate server (e.g., target cluster) member by removing, adding, or changing the order dynamically in the ordered list of client affinities. The database driver may cycle through the cluster members in the updated ordered list to route the connection to the new cluster member. The application may re-execute the Standard Query Language (SQL) commands with session resources after failover using an ACR algorithm. The connection may occur in the background at the database driver layer with little or no impact on application resiliency.

Aspects of the disclosure relate to a system, method, and computer program product for using a database driver to manage application resiliency with respect to a shared pool of configurable computing resources. A transaction request having a set of command data may be received. An updated set of global property data for the database driver may be detected. The updated set of global property data for the database driver may be captured in a memory device coupled with the database driver. An operational member asset of the shared pool of configurable computing resources may be determined to process the transaction request. The transaction request may be connected with the operational member asset of the shared pool of configurable computing resources. The set of command data for the transaction request may be transmitted to the operational member of the shared pool of configurable computing resources.

In embodiments, a user may update the global property file of the database driver. The user update of the global property file may include removing the cluster member from the ordered list, adding a new cluster member to the ordered list, or changing the order of the cluster members in the ordered list. In certain embodiments, the global property file may be monitored (using a daemon thread) for an indication of the updated set of global property data. In various embodiments, an unplanned outage may occur. An entry for the operational member asset may be added to the updated set of global property data and the transaction request may be carried-out without interaction with the source application. Altogether, performance or efficiency benefits related to using a database driver to manage application resiliency with respect to a shared pool of configurable computing resources may occur (e.g., speed, flexibility, load balancing, responsiveness, high availability, resource usage, productivity). Aspects may save computing resources such as bandwidth, processing, or memory. As an example, processing time may be saved through application resiliency management. Aspects may dynamically update alternate server information to increase application resiliency. Queries, such as transaction requests, may be automatically and dynamically rerouted (on a continual basis without manual intervention) to enhance application resiliency. This may require less processing time (than a user manually resubmitting/rerouting the query) while also having higher availability of the system. Other examples of using application resiliency management to save processing time may also be possible.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

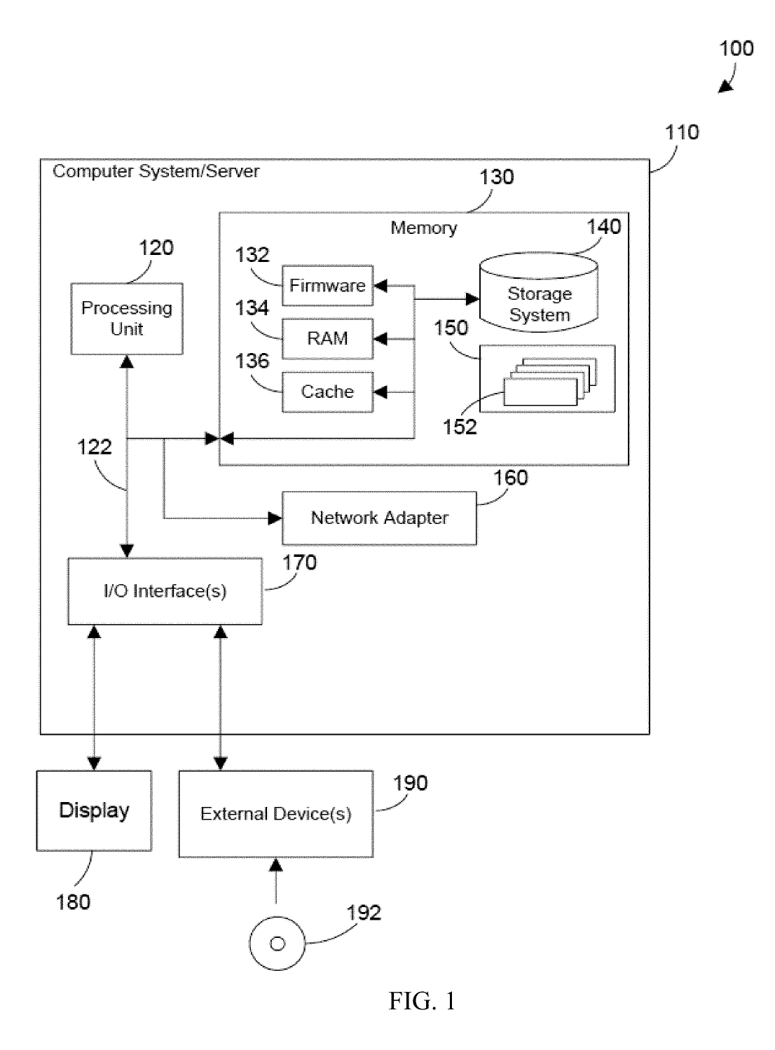

Referring now to FIG. 1, a block diagram of an example of a cloud computing node is shown. Cloud computing node 100 is only one example of a suitable cloud computing node and is not intended to suggest any limitation as to the scope of use or functionality of embodiments of the invention described herein. Regardless, cloud computing node 100 is capable of being implemented and/or performing any of the functionality set forth hereinabove.

In cloud computing node 100 there is a computer system/server 110, which is operational with numerous other general purpose or special purpose computing system environments or configurations. Examples of well-known computing systems, environments, and/or configurations that may be suitable for use with computer system/server 110 include, but are not limited to, personal computer systems, server computer systems, tablet computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 110 may be described in the general context of computer system executable instructions, such as program modules, being executed by a computer system. Generally, program modules may include routines, programs, objects, components, logic, data structures, and so on that perform particular tasks or implement particular abstract data types. Computer system/server 110 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 110 in cloud computing node 100 is shown in the form of a general-purpose computing device. The components of computer system/server 110 may include, but are not limited to, one or more processors or processing units 120, a system memory 130, and a bus 122 that couples various system components including system memory 130 to processing unit 120.

Bus 122 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 110 typically includes a variety of computer system readable media. Such media may be any available media that is accessible by computer system/server 110, and it includes both volatile and non-volatile media, removable and non-removable media. An example of removable media is shown in FIG. 1 to include a Digital Video Disc (DVD) 192.

System memory 130 can include computer system readable media in the form of volatile or non-volatile memory, such as firmware 132. Firmware 132 provides an interface to the hardware of computer system/server 110. System memory 130 can also include computer system readable media in the form of volatile memory, such as random access memory (RAM) 134 and/or cache memory 136. Computer system/server 110 may further include other removable/non-removable, volatile/non-volatile computer system storage media. By way of example only, storage system 140 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 122 by one or more data media interfaces. As will be further depicted and described below, memory 130 may include at least one program product having a set (e.g., at least one) of program modules that are configured to carry out the functions described in more detail below.

Program/utility 150, having a set (at least one) of program modules 152, may be stored in memory 130 by way of example, and not limitation, as well as an operating system, one or more application programs, other program modules, and program data. Each of the operating system, one or more application programs, other program modules, and program data or some combination thereof, may include an implementation of a networking environment. Program modules 152 generally carry out the functions and/or methodologies of embodiments of the invention as described herein.

Computer system/server 110 may also communicate with one or more external devices 190 such as a keyboard, a pointing device, a display 180, a disk drive, etc.; one or more devices that enable a user to interact with computer system/server 110; and/or any devices (e.g., network card, modem, etc.) that enable computer system/server 110 to communicate with one or more other computing devices. Such communication can occur via Input/Output (I/O) interfaces 170. Still yet, computer system/server 110 can communicate with one or more networks such as a local area network (LAN), a general wide area network (WAN), and/or a public network (e.g., the Internet) via network adapter 160. As depicted, network adapter 160 communicates with the other components of computer system/server 110 via bus 122. It should be understood that although not shown, other hardware and/or software components could be used in conjunction with computer system/server 110. Examples, include, but are not limited to: microcode, device drivers, redundant processing units, external disk drive arrays, Redundant Array of Independent Disk (RAID) systems, tape drives, data archival storage systems, etc.

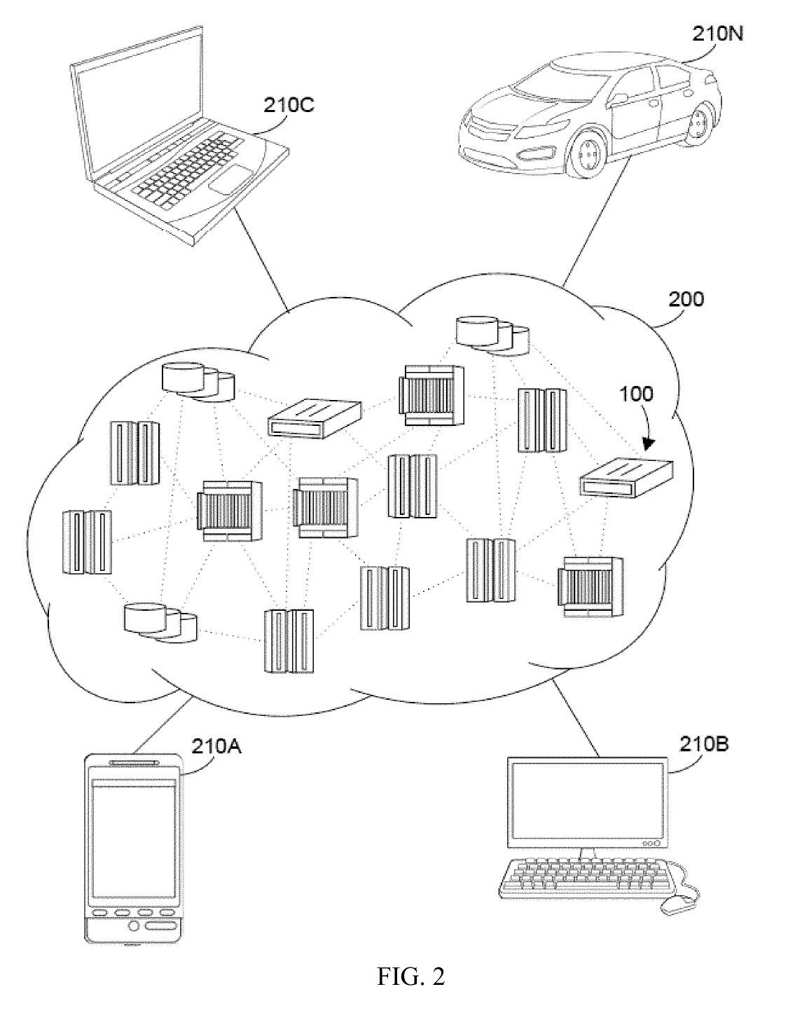

Referring now to FIG. 2, illustrative cloud computing environment 200 is depicted. As shown, cloud computing environment 200 comprises one or more cloud computing nodes 100 with which local computing devices used by cloud consumers, such as, for example, personal digital assistant (PDA) or cellular telephone 210A, desktop computer 210B, laptop computer 210C, and/or automobile computer system 210N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 200 to offer infrastructure, platforms and/or software as services for which a cloud consumer does not need to maintain resources on a local computing device. It is understood that the types of computing devices 210A-N shown in FIG. 2 are intended to be illustrative only and that computing nodes 100 and cloud computing environment 200 can communicate with any type of computerized device over any type of network and/or network addressable connection (e.g., using a web browser).

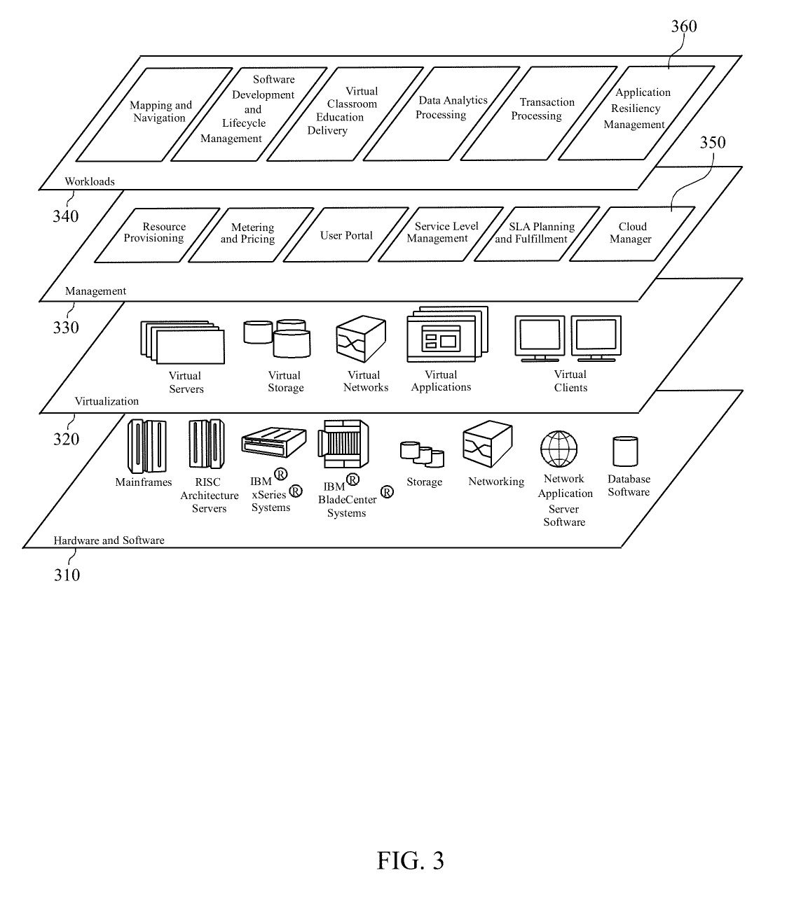

Referring now to FIG. 3, a set of functional abstraction layers provided by cloud computing environment 200 in FIG. 2 is shown. It should be understood in advance that the components, layers, and functions shown in FIG. 3 are intended to be illustrative only and the disclosure and claims are not limited thereto. As depicted, the following layers and corresponding functions are provided.

Hardware and software layer 310 includes hardware and software components. Examples of hardware components include mainframes, in one example IBM System z systems; RISC (Reduced Instruction Set Computer) architecture based servers, in one example IBM System p systems; IBM System x systems; IBM BladeCenter systems; storage devices; networks and networking components. Examples of software components include network application server software, in one example IBM Web Sphere® application server software; and database software, in one example IBM DB2® database software. IBM, System z, System p, System x, BladeCenter, WebSphere, and DB2 are trademarks of International Business Machines Corporation registered in many jurisdictions worldwide.

Virtualization layer 320 provides an abstraction layer from which the following examples of virtual entities may be provided: virtual servers; virtual storage; virtual networks, including virtual private networks; virtual applications and operating systems; and virtual clients.

In one example, management layer 330 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA. A cloud manager 350 is representative of a cloud manager (or shared pool manager) as described in more detail below. While the cloud manager 350 is shown in FIG. 3 to reside in the management layer 330, cloud manager 350 can span all of the levels shown in FIG. 3, as discussed below.

Workloads layer 340 provides examples of functionality for which the cloud computing environment may be utilized. Examples of workloads and functions which may be provided from this layer include: mapping and navigation; software development and lifecycle management; virtual classroom education delivery; data analytics processing; transaction processing; and an application resiliency management layer 360, which relates to using a database driver as discussed in more detail herein.

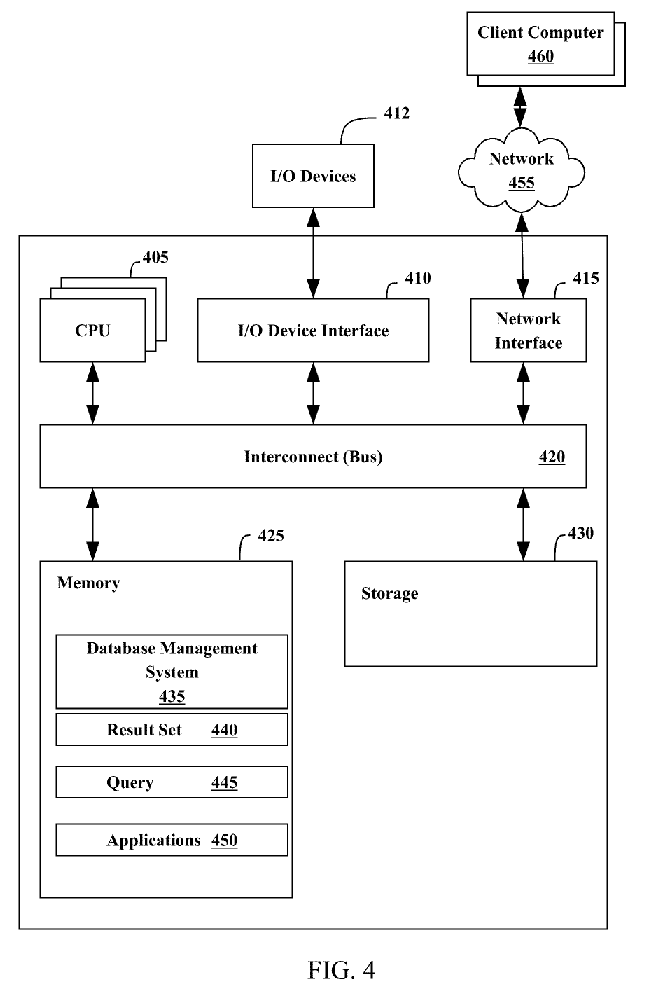

FIG. 4 illustrates an example representation of a computer system 400 connected to one or more client computers 460 via a network 455, according to some embodiments. For the purposes of this disclosure, computer system 400 may represent practically any type of computer, computer system, or other programmable electronic device, including but not limited to, a client computer, a server computer, a portable computer, a handheld computer, an embedded controller, etc. In some embodiments, computer system 400 may be implemented using one or more networked computers, e.g., in a cluster or other distributed computing system.

The computer system 400 may include, without limitation, one or more processors (CPUs) 105, a network interface 415, an interconnect 420, a memory 425, and a storage 430. The computer system 400 may also include an I/O device interface 410 used to connect I/O devices 412, e.g., keyboard, display, and mouse devices, to the computer system 400.

Each processor 405 may retrieve and execute programming instructions stored in the memory 425 or storage 430. Similarly, the processor 405 may store and retrieve application data residing in the memory 425. The interconnect 420 may transmit programming instructions and application data between each processor 405, I/O device interface 410, network interface 415, memory 425, and storage 430. The interconnect 420 may be one or more busses. The processor 405 may be a single central processing unit (CPU), multiple CPUs, or a single CPU having multiple processing cores in various embodiments. In one embodiment, a processor 405 may be a digital signal processor (DSP).

The memory 425 may be representative of a random access memory, e.g., Static Random Access Memory (SRAM), Dynamic Random Access Memory (DRAM), read-only memory, or flash memory. The storage 430 may be representative of a non-volatile memory, such as a hard disk drive, solid state device (SSD), or removable memory cards, optical storage, flash memory devices, network attached storage (NAS), or connections to storage area network (SAN) devices, or other devices that may store non-volatile data. The network interface 415 may be configured to transmit data via the communications network 455.

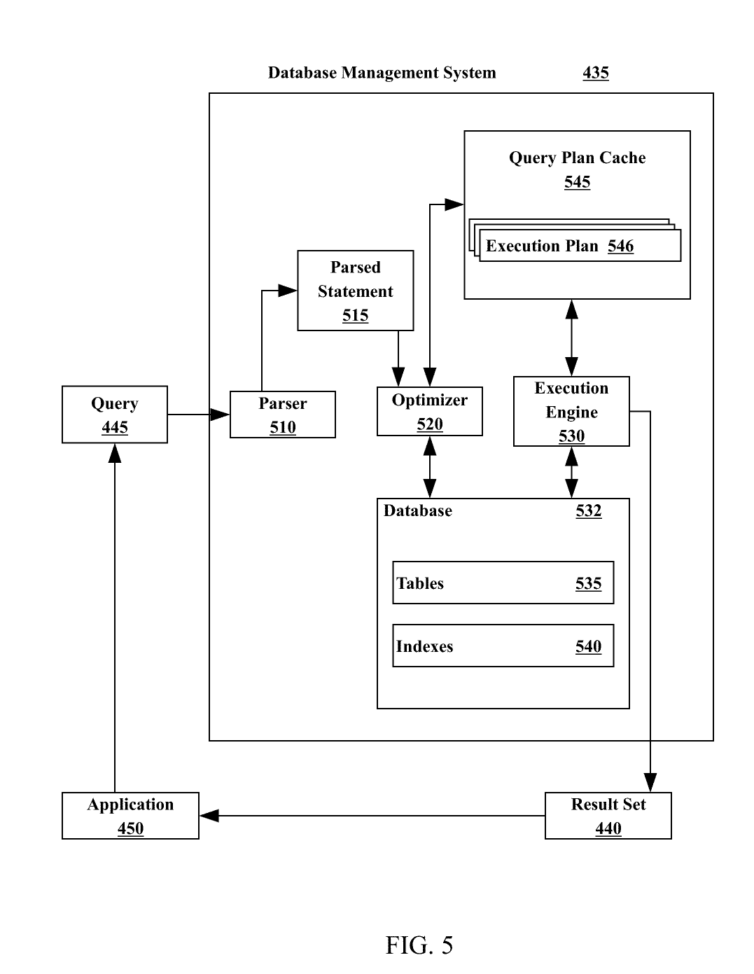

The memory 425 may include a database management system (DBMS) 435, a result set 440, a query 445, and applications 450. Although these elements are illustrated as residing in the memory 425, any of the elements, or combinations thereof, may reside in the storage 430 or partially in the memory 425 and partially in the storage 430. Each of these elements will be described in greater detail in accordance with FIG. 5.

The network 455 may be any suitable network or combination of networks and may support any appropriate protocol suitable for communication of data and/or code to/from the server computer system 400 and the client computer system 460. In some embodiments, the network 455 may support wireless communications. In other embodiments, the network 455 may support hardwired communications. The network 455 may be the Internet and may support Internet Protocol in some embodiments. In other embodiments, the network 455 may be implemented as a local area network (LAN) or a wide area network (WAN). The network 455 may also be implemented as a cellular data network. Although the network 455 is shown as a single network in the figures, one or more networks of the same or different types may be included.

The client computer system 460 may include some or all of the hardware and software elements of the computer system 400 previously described. As shown, there may be one or more client computers 460 connected to the computer system 400 via the network 455. In some embodiments, one or more client computers 460 may send a query 445 by network 455 to computer system 400 and receive a result set 440.

FIG. 5 illustrates an example database management system (DBMS) 435. The DBMS 435 may include a parser 510, an optimizer 520, an execution engine 530, and a database 532. The parser 510 may receive a database query 445 from an application 450. In some embodiments, the database query 445 may be in the form of a Structured Query Language (SQL) statement. The parser 510 may generate a parsed statement 515. The parser 510 may send the parsed statement 515 to an optimizer 520. The optimizer 520 may attempt to optimize the parsed statement. In some embodiments, optimizing may improve the performance of the database query 445 by, for example, reducing the amount of time it takes to provide a user with a response. The optimizer 520 may generate an execution plan 546 (may also be referred to as a query plan or an access plan), which may be maintained in a query plan cache 545, according to some embodiments. The query plan cache 545 may include one or more execution plans 546, including the current execution plan as well as previously used execution plans. Once an execution plan 546 is generated, the execution plan 546 may be sent to the execution engine 530. The execution engine 530 may execute the query 445. Executing the query 445 may include finding and retrieving data in the database tables 535 that satisfies the criteria supplied in the query 445. The execution engine 530 may store the data returned matching the query 445 in a result set 440. The DBMS 435 may return the result set 440 to an application 450, such as the application in which the database query 445 was generated, as a response to the database query 445.

A database 532 may include one or more tables 535 and, in some embodiments, one or more indexes 540. A database table 535 may organize data into rows and columns. Each row of a database table 535 may correspond to an individual entry, a tuple, or a record in the database 532. A column may define what is stored in each entry, tuple, or record. In some embodiments, columns of a table 535 may also be referred to as fields or attributes. Each table 535 within the database 532 may have a unique name. Each column within a table 535 may also have a unique name. A row, tuple, or record, however, within a particular table 535 may not be unique, according to some embodiments. A database 532 may also include one or more indexes 540. An index 540 may be a data structure that may inform the DBMS 435 of the location of a particular record within a table 535 if given a particular indexed column value. In some embodiments, the execution engine 530 may use the one or more indexes 540 to locate data within a table 535. In other embodiments, the execution engine 530 may scan the tables 535 without using an index 540.

As mentioned herein, the optimizer 520 creates the query access plan. The optimizer 520 may be implemented as computer program instructions that optimize the access plan in dependence upon database management statistics. Database statistics may reveal, for example, that there are only two identification values in a transactions table—so that it is an optimization, that is, more efficient, to scan the transactions table rather than using an index. Alternatively, database statistics may reveal that there are many transaction records with only a few transaction records for each identification value—so that it is an optimization, that is, more efficient, to access the transaction records by an index.

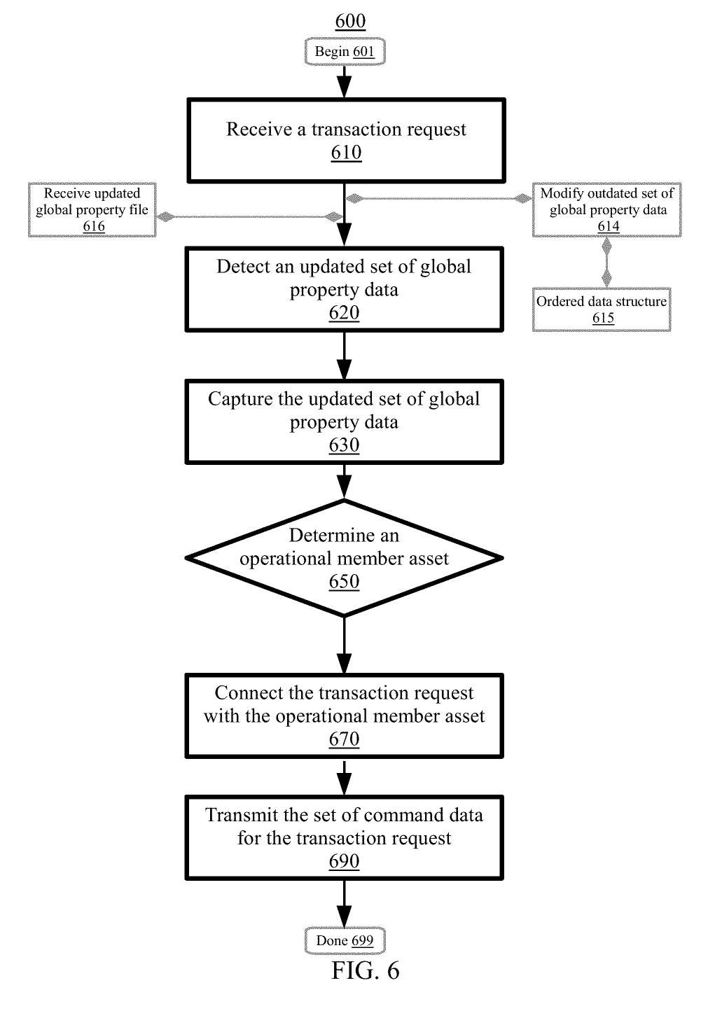

FIG. 6 is a flowchart illustrating a method 600 of using a database driver to manage application resiliency with respect to a shared pool of configurable computing resources. Application resiliency may be achieved by updating information regarding new alternate cluster members dynamically (e.g., on-the-fly during the application execution, without restarting/reloading the application/database driver/virtual machine) during an outage, service failure, or site failure for existing primary and secondary clusters. Application resiliency may utilize a database driver to process transaction requests. The database driver may include a software component which enables an application to interact with a database, such as a Java Database Connectivity (JDBC, trademark of Sun Microsystems, Inc.) an Open Database Connectivity (ODBC), or the like. The method 600 may begin at block 601.

At block 610, a transaction request may be received. Generally, receiving can include acquiring, obtaining, attaining, collecting, detecting, accepting, or recognizing. The receiving may occur by the database driver or by a memory device coupled with the database driver. The transaction request may have a set of command data. The set of command data may include programming language, such as a Standard Query Language (SQL) statement. The set of command data may include a set of ordered SQL data (e.g., a write request).

Consider the following example. A retail store may use a database driver to manage application resiliency with respect to a shared pool of configurable computing resources. The database driver of the retail store may receive a transaction request. In a retail environment, the transaction request may include a query, statement, or the like related to a lists of items purchased, a table of transactions sorted by date, metadata with respect to specific transactions (e.g., time, date, number of items, location), a list of total cost for various transactions, or similar. The retail store may submit a transaction request to the database driver to sort or select specific types of data (e.g., items purchased, date of transactions). The transaction request may include SQL commands, such as SHOW TABLES, SELECT Tuesday_transactions, ORDER BY amount_spent, or the like. Other examples of receiving a transaction request having a set of command data may also be possible.

In embodiments, an outdated set of global property data may be modified at block 614. Modifying can include adjusting, altering, repairing, fixing, revising, or changing. The modifying may occur to establish the updated set of global property data for the database driver. The user may update the assets of the shared pool of configurable computing resources in an ordered list in the global property file. The updating may include adding, removing, or changing the order of the assets in the ordered list. The user may update the assets for both planned and unplanned situations (e.g., maintenance activities, outages, domain failures, zone failures). Planned and unplanned situations may result in a full or partial failure of a database connection. The set of global property data for the failed database connection may become the outdated set of global property data. The user may wish to input an updated set of global property data which may not result in a failed database connection. The modifying may also occur automatically by the system adding, removing, or changing the order of the assets without manual stimuli such as intervention by an administrator. The modifying may occur in a dynamic (e.g., on-going, on-the-fly) fashion.

In embodiments, the memory device may include an ordered data structure at block 615. The ordered data structure (e.g., multidimensional array, table, list) may include an ordered list, such as the list of assets in a shared pool of configurable computing resources which act as alternate servers. A first cluster member entry for a first cluster member may be removed from an ordered data structure. Removing can include deleting, dismissing, eliminating, or getting rid of a first cluster member entry. A second cluster member entry for a second cluster member may be added to the ordered data structure. Adding can include adjoining, affixing, or appending a second cluster member entry. An order of cluster member entries may be changed in the ordered data structure. The changing may include rearranging a third cluster member entry for a third cluster member. Changing can include modifying, adjusting, altering, or revising a third cluster member entry. The third cluster member entry for a third cluster member may rearranged (e.g., reorganized, repositioned) to be subsequent to a fourth cluster member entry for a fourth cluster member. The outdated set of global property data may have had the fourth cluster member entry for the fourth cluster member subsequent to the third cluster member entry for the third cluster member (e.g., rearranging cluster member entries from [THREE, FOUR] to [FOUR, THREE]). The rearranging may occur in the ordered data structure to establish the updated set of global property data for the database driver.

Consider the following example. A bank may use a database driver to manage application resiliency with respect to a shared pool of configurable computing resources. The database driver of the bank may receive a transaction request which includes SQL commands to create a table of recent transactions for a specific customer (e.g., SHOW TABLE account_holder_3510). The SQL command may be processed by flowing to members (m1, m2) in an ordered list. An outage may occur, resulting in a desire to reroute the SQL command to a modified ordered list of members. m1 may be the member in the ordered list which is causing the outage. In one example, m1 may be removed from the ordered list and the SQL command may be rerouted to m2. In another example, a third member (m3) may be added to the ordered list and the SQL command may be rerouted to m3. In another example, the ordered list may be rearranged from [m1, m2] to [m2, m1]. The SQL command may be rerouted to m2 to process the request. By rerouting the SQL command to a different member, the transaction request may be processed, and a table displaying recent transactions for Account Holder 3510 may be created. Other examples of modifying an outdated set of global property data with an ordered data structure may also be possible.

In embodiments, an updated global property file may be received at block 616. Receiving can include acquiring, obtaining, attaining, collecting, detecting, accepting, or recognizing. The updated global property file may include the updated set of global property data for the database driver (e.g., the modified outdated set of global property data as described herein). The updated global property file may be received from a user, an administrator, another computer, etc. During the planned or unplanned activities (at server side), the user may update (e.g., remove cluster member entry, add cluster member entry, rearrange cluster member entries) the global property file of the database driver, such as Open Database Connectivity (ODBC), Java Database Connectivity (JDBC), or the like. The updated global property file may also include updated resource or updated storage in the ordered list.

Consider the following example. A healthcare center may use a database driver to manage application resiliency with respect to a shared pool of configurable computing resources. The database driver of the healthcare center may receive a transaction request which includes SQL commands to display X-rays for a specific patient (e.g., SELECT X_ray_patient_513). The SQL command may be routed to a member entry which may experience an outage, and an outdated set of global property data may be modified to establish an updated set of global property data. As an example, a cluster member entry (e.g., m4) may have been added to the ordered data structure to process the request. The updated ordered structure, including the updated set of global property data, may be received without the sender reentering a new command/request/code. In this way, the SQL command may be processed, and the X-ray information for Patient 513 may be displayed to the recipient without various delays or burdens due to an outage or maintenance. Other examples of receiving an updated global property file may also occur.

At block 620, an updated set of global property data for the database driver may be detected. Detecting can include sensing, receiving, recognizing, identifying, discovering, or ascertaining. The updated set of global property data for the database driver may be established by a user or administrator updating (e.g., removing, adding, changing the order) the alternate server (e.g., target cluster) member dynamically in the ordered list of client affinities as described herein. The updated set of global property data may include the changes or modifications (as described herein) made to the original (e.g., outdated) set of global property data in order to process a transaction request. The database driver may utilize the updated set of global property data to reroute a transaction request to cluster members. The individual cluster members (e.g., entries, data, records, values of entries) may be used to perform the routing (as opposed to the data structure). At block 630, the updated set of global property data for the database driver may be captured. Capturing can include collecting, gathering, recording, obtaining, or acquiring the updated set of global property data. If there is an update to the set of global property data, the ordered list may be updated in the memory of the database driver. The capturing may occur in a memory device coupled (e.g., combined, connected) with the database driver.

Consider the following example. A government department may use a database driver to manage application resiliency with respect to a shared pool of configurable computing resources. The database driver of the government may receive a transaction request which includes SQL commands to arrange information gathered from civilian defense workers in various global locations (e.g., ORDER BY location_alphabetically). An updated set of global property data may be detected. The updated set of global property may be established by modifying an ordered structure as described herein. As an example, an erroneous member (e.g., m3) may be removed from the ordered list. A government user or administrator may detect the update and make the necessary changes in the ordered list. The government user or administrator may remove m3 from the ordered list to process the SQL request. Once the updated set of global property data is captured, the ordered list may also be updated in the memory of the database driver. By removing m3 from the ordered list, the SQL command may be executed, and defense information may be sorted alphabetically based on location of the civilian defense worker. Other examples of detecting and capturing the updated set of global property data may also be possible.

At block 650, an operational member asset of the shared pool of configurable computing resources may be determined. Determining can include formulating, computing, resolving, or ascertaining an operational member asset. The operational member asset may include a component used to reroute a transaction request. The operational member asset may include components which are fully operational, not experiencing an error, undergoing little or no maintenance, includes a minor error but still operational at a desired capacity, or the like. The determining may occur based on the updated set of global property data for the database driver. The database driver may use client affinities to cycle through cluster members in the updated (e.g., added, removed, rearranged) ordered list. The failed connection may be rerouted to the new cluster member. The determining may occur related to an automatic client reroute (ACR) operation. ACR may provide high availability in a cluster environment. Through ACR, a database connection that suffered an outage may be recovered by being re-associated to the alternate server. The determining may occur to process the transaction request.

Consider the following example. An insurance company may use a database driver to manage application resiliency with respect to a shared pool of configurable computing resources. The database driver of the insurance company may receive a transaction request which includes SQL commands to display clients with both automobile and homeowner insurance (e.g., SELECT clients_automobile_homeowner). The database connection to a default asset may experience an outage. An operational member asset may be determined based on the updated set of global property data for the database driver. One asset (e.g., m2) may be fully operational. The database driver may cycle through the updated ordered list and reroute the transaction request to the fully-operational asset (m2). In this way, the database connection may be salvaged by being routed to the fully operational member (m2) of the alternate server without additional work on the part of the insurance agent. The SQL command may be executed, and a list of clients with both an automobile plan and a homeowner plan may be displayed. In another example, an asset (e.g., m4) may be experiencing an error which causes an outage. The database driver may cycle through the updated ordered list and reroute the transaction request around m4 (e.g., exclude m4 from the transmitting of the transaction request). In this way, the database connection that suffered an outage may be recovered by being rerouted away from an erroneous member (m4). The SQL command may be executed, and the desired client list may be displayed. Other examples of determining an operational member asset may also be possible.

At block 670, the transaction request may be connected with the operational member asset of the shared pool of configurable computing resources. Connecting may include attaching, joining, linking, combining, or coupling the transaction request and the operational member asset. Once the ordered list is updated, the database driver may reroute the connections to a new asset of the shared pool of configurable computing resources. The connecting may occur using the ACR operation. The connection reroute may take place in the background within the database driver. Application resiliency may not experience a substantial or recognizable negative impact through usage of the ACR operation. The connecting may occur to process the transaction request.

Consider the following example. A stock exchange may use a database driver to manage application resiliency with respect to a shared pool of configurable computing resources. The database driver of the stock exchange may receive a transaction request which includes SQL commands to create a table arranging benchmark stock averages over the course of the week (e.g., SHOW TABLE weekly_average_DJIA_Nasdaq). An operational member asset of the shared pool of configurable computing resources may be determined. As an example, a specific member (m1) may be fully operational. The database driver may reroute the connection to m1 of the shared pool of configurable computing resources using the ACR operation. The connection reroute may take place in such a way that the stockbroker that submitted the SQL request may not experience a recognizable impact due to the rerouting. The SQL command may be executed, and the table may be displayed to the stockbroker. Other examples of connecting the transaction request with the operational member asset of the shared pool of configurable computing resources may also be possible.

At block 690, the set of command data may be transmitted for the transaction request. Transmitting can include providing, sending, conveying, or delivering the set of command data. The database driver may re-execute the SQL transactions with session resources after failure/failover. The set of command data may be transmitted to the operational member asset of the shared pool of configurable computing resources. The transmitting may occur to process the transaction request. The connection reroute may occur in the background by the database driver with no/little impact on application resiliency (e.g., no loss of data/transactions, seamless transaction).

Consider the following example. A retail store may use a database driver to manage application resiliency with respect to a shared pool of configurable computing resources. The database driver of the retail store may receive a transaction request which includes SQL commands to arrange daily transactions from most recent to oldest (e.g., ORDER BY time). An operational member asset of the shared pool of configurable computing resources may be determined. As an example, member m may be experiencing an error, so the transaction request may instead be connected with member m2 to process the SQL command. The SQL command data may be transmitted to operational member asset m2. m2 may be utilized to reroute and process the transaction request. The reroute may occur in the background by the database driver without a loss of data. The SQL command may be executed and the daily transactions may be arranged in the desired order. Other examples of transmitting the set of command data for the transaction request may also be possible.

Method 600 concludes at block 699. Aspects of method 600 may provide performance or efficiency benefits related to using a database driver to manage application resiliency. Aspects may save resources such as bandwidth, processing, or memory. As an example, processing time may be saved by transmitting the set of command data for the transaction request to the operational member asset of the shared pool of configurable computing resources. The database driver may reroute the SQL transactions dynamically (in the background) with no loss of data or transactions. This may prevent a user from manually having to resubmit the SQL transaction, which may decrease processing time. Other examples of using application resiliency management to save processing time may also be possible.

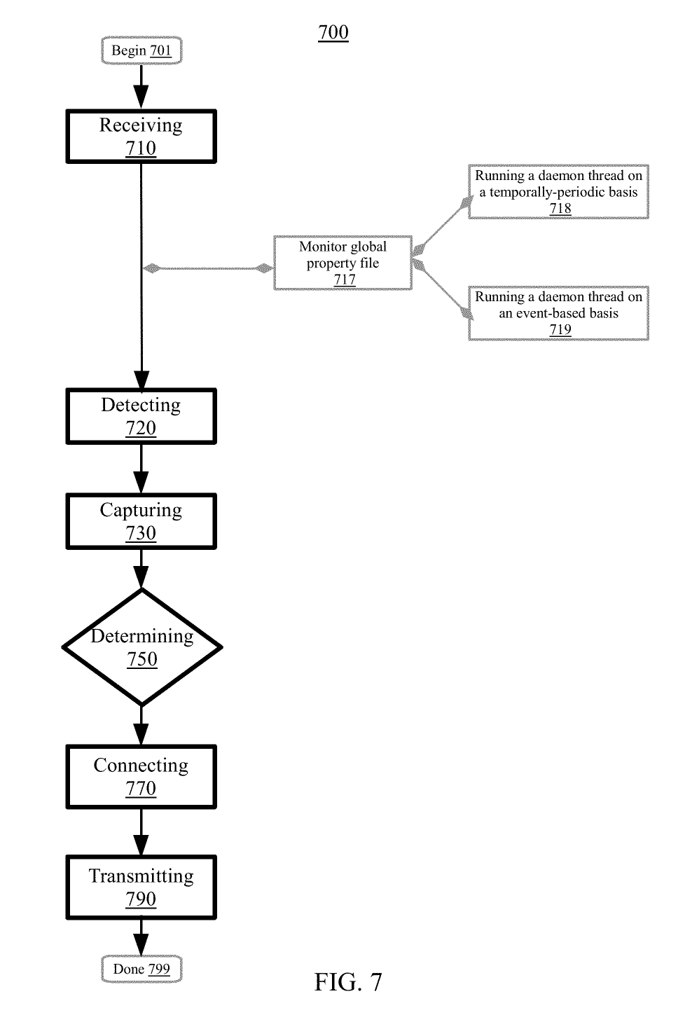

FIG. 7 is a flowchart illustrating a method 700 of using a database driver to manage application resiliency with respect to a shared pool of configurable computing resources. Aspects may be similar or the same as aspects of method 600, and aspects may be utilized interchangeably with one or more methodologies described herein. The method 700 may begin at block 701. At block 710, a transaction request may be received. The transaction request may have a set of command data.

In embodiments, a global property file may be monitored at block 717. Monitoring can include tracking, listening, observing, checking, or watching for an update. The monitoring may be performed by the database driver. The global property file may be monitored for an indication of the updated set of global property data for the database driver. The indication of the updated set of global property data may include a removal of a specific member from the ordered list, an addition of a specific member from the ordered list, a rearranging of members of the ordered list, or the like.

In embodiments, a daemon thread may be run at block 718. Running can include executing, performing, implementing, or carrying-out a daemon thread. A daemon thread may include a low-priority thread which runs in the background to perform tasks. The daemon thread may be run to monitor the global property file. The daemon thread may check for the indication of the updated set of global property data for the database driver on a temporally-periodic basis. The database driver may (automatically) run a daemon thread periodically at a regular interval of time (e.g., every 60 seconds, every 60 minutes, at noon every day, once a week) to check for an update to the global property file. The database driver may run a daemon thread periodically whether members are changed or not.

Consider the following example. A bank may use a database driver to manage application resiliency with respect to a shared pool of configurable computing resources. The database driver of the bank may receive a transaction request which includes SQL commands to display transactions which may contain instances of fraud (e.g., SELECT fraud_event). The database driver may monitor a global property file for an indication of the updated set of global property data. As an example, members m1 and m2 may be rearranged from [m1, m2] to [m2, m1] in order to process the transaction request. The rearranged members may indicate an updated set of global property data. The database driver may detect the updated set of global property data by running a daemon thread on a temporally-periodic basis. The database driver may run a daemon thread every sixty seconds to check for an indication of the updated set of global property data. After sixty seconds, the database driver may detect the rearranged ordered list. The transaction request may be connected with the operational rearranged list for processing. The SQL command may be executed and a list of fraud activities may be displayed to the credit analyst. Other examples of running a daemon thread on a temporally-periodic basis to monitor for an indication of the updated set of global property data may also be possible.

In embodiments, a daemon thread may be run at block 719. Running can include executing, performing, implementing, or carrying-out a daemon thread. The daemon thread may be run to monitor the global property file. The daemon thread may check for the indication of the updated set of global property data for the database driver on an event-based basis. The daemon thread may be run automatically in response to a specific event. The event may include an error event such as a power outage, a user input, a user initiate, an expected processing of a large batch of data, or the like.

Consider the following example. A healthcare center may use a database driver to manage application resiliency with respect to a shared pool of configurable computing resources. The database driver of the healthcare center may receive a transaction request which includes SQL commands to display a list of patients that recently underwent heart surgery (e.g., SELECT patients_surgery_cardiovascular). The database driver may monitor a global property file for an indication of the updated set of global property data. As an example, member m4 may be experiencing an outage, and may be removed from the ordered list. The new ordered list (without m4) may indicate an updated set of global property data. The database driver may detect the updated set of global property data by running a daemon thread on an event-based basis. The database driver may run a daemon thread in response to a power outage to check for an indication of the updated set of global property data. After a power outage occurs, the database driver may detect the new ordered list without member m4. The transaction request may be connected with the operational member asset for processing. The SQL command may be executed and a list of patients that recently underwent heart surgery may be displayed to the healthcare professional. Other examples of running a daemon thread on an event-based basis to monitor for an indication of the updated set of global property data may also be possible.

At block 720, an updated set of global property data for the database driver may be detected. At block 730, the updated set of global property data for the database driver may be captured. The capturing may occur in a memory device coupled with the database driver. At block 750, an operational member asset of the shared pool of configurable computing resources may be determined. The determining may occur based on the updated set of global property data for the database driver. The determining may occur related to an ACR operation. The determining may occur to process the transaction request. At block 770, the transaction request may be connected with the operational member asset of the shared pool of configurable computing resources. The connecting may occur using the ACR operation. The connecting may occur to process the transaction request. At block 790, the set of command data may be transmitted for the transaction request. The set of command data may be transmitted to the operational member asset of the shared pool of configurable computing resources. The transmitting may occur to process the transaction request.

Method 700 concludes at block 799. Aspects of method 700 may provide performance or efficiency benefits related to using a database driver to manage application resiliency. Aspects may save resources such as bandwidth, processing, or memory. As an example, a memory may be saved by running a daemon thread to monitor the global property file. The daemon thread may be run on a temporally-periodic or event-based basis to check for an indication of the updated set of global property data. This may prevent an administrator from manually running a daemon thread (or using another method) to check for an indication of the updated set of global property data. In this way, memory may be saved. Other methods of using application resiliency management to save memory may also be possible.

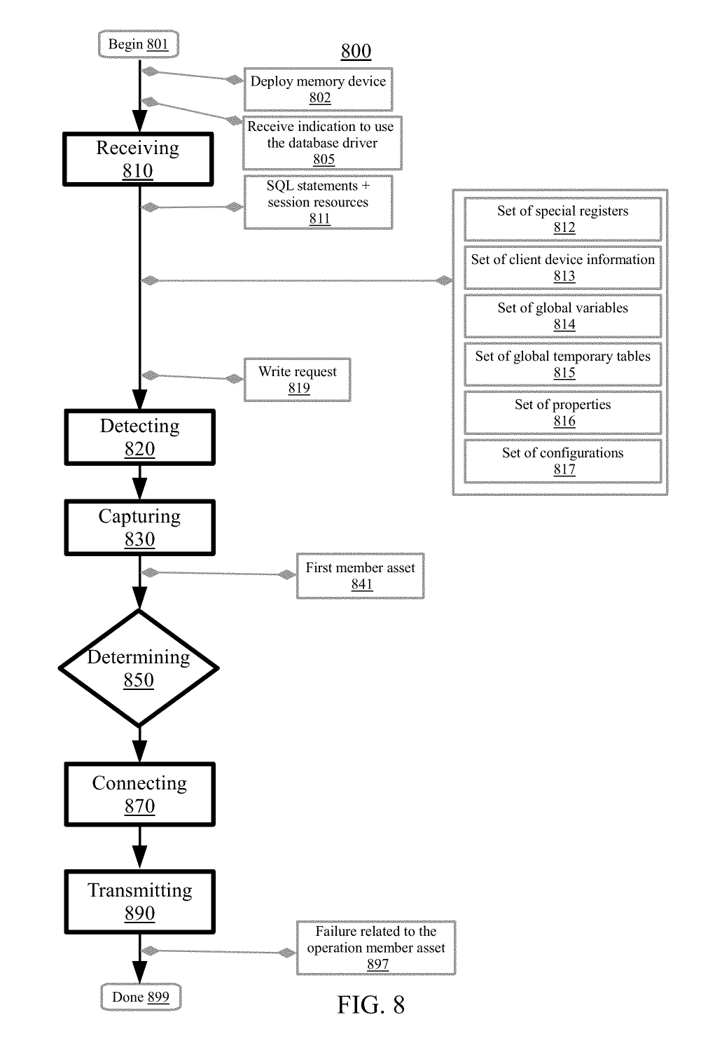

FIG. 8 is a flowchart illustrating a method 800 of using a database driver to manage application resiliency with respect to a shared pool of configurable computing resources. Aspects may be similar or the same as aspects of method 600/700, and aspects may be utilized interchangeably with one or more methodologies described herein. The method 800 may begin at block 801.

In embodiments, the memory device coupled with the database driver may be deployed at block 802. Deploying can include establishing, constructing, configuring, or utilizing. The memory device may be coupled (e.g., connected, combined) with the database driver to capture the updated set of global property data as described herein. The deploying may occur at a first physical location which differs from a set of locations having the shared pool of configurable computing resources. The first physical location may differ from (e.g., be physically separate from) a set of (physical) locations having the shared pool of configurable computing resources. For example, the database driver may be located in a first country (e.g., United States) and the shared pool of configurable computing resources may be located in a second country (e.g., England, France, Canada). A government unit located in the United States may use a database driver to collect and sort economic information from various countries. The shared pool of configurable computing resources may be located in other countries around the world. The database driver may capture the updated set of global property data from various physical locations in various countries. Other examples of coupling the memory device with the database driver may also occur.

In embodiments, an indication to use the database driver to manage application resiliency may be received at block 805. Receiving can include detecting, collecting, recognizing, acquiring, sensing, or accepting an indication. The indication may be received in a package with the transaction request, received from a user separate from the transaction request as applied to transaction requests which meet a predetermined selection, or the like. The indication may be received in advance of capturing the set of command data for the transaction request. The indication to use the database driver to manage application resiliency may be without a set of application-originated code to handle an error event. Accordingly, a selection may be made to enable management of application resiliency as described herein. Selection can include, for example, saving a data value (e.g., entering a digit/character in a data store), transmitting a data object (e.g., sending an object having metadata), routing a message (e.g., publishing a start-up/wait expectation), or providing/performing/processing an operation (e.g., a notification). As an example, an insurance company may desire to use a database driver to manage application resiliency. A specific insurance agent may indicate a desire to use the database driver to manage application resiliency in a package with the transaction request. The insurance agent may make a selection by entering a digit (e.g., entering “1” to enable application resiliency management). The insurance agent may make a selection by processing an operation (e.g., selecting a button on a notification to enable application resiliency management). The database driver may be used to manage application resiliency and process transaction requests entered by the insurance agent. Other examples of receiving an indication to use the database driver to manage application resiliency may also be possible. At block 810, a transaction request may be received. The transaction request may have a set of command data.

In embodiments, the set of command data may be configured at block 811. Configuring can include setting-up, programming, adjusting, instructing, revising, or modifying the set of command data. The command data may be configured to include both a set of SQL statements and a set of session resources. In embodiments, the set of command data may include a set of SQL data (e.g., SQL commands, statements, parameters, inputs, values). A set of ordered SQL data may be received by the database driver. Other forms of database commands such as driver application programming interface (API) calls or commands which configure session resources (e.g., special registers) may be received. Accordingly, various types of commands, statements, parameters, or code are considered with respect to the set of command data as received from a client application. As an example, a transaction request may be submitted by the manager of a retail store. The transaction request may include a set of command data which may include a set of SQL statements and a set of session resources. The transaction request may include an SQL command to display all transactions from a range of dates which included a food item experiencing a recall (e.g., SELECT May_lettuce). The transaction request may include a database command which includes session resources (e.g., a command to sort the described list of transactions by brand of lettuce). Other examples of configuring the set of command data may also be possible.

In embodiments, the set of session resources may be configured. Configuring can include setting-up, programming, adjusting, instructing, revising, or modifying the set of session resources. The set of session resources may be configured to include a set of special registers at block 812 (e.g., having a specific control or data handling task to carry out), a set of client device information at block 813 (e.g., state information, authentication information, security information, optimization information, network access information), a set of global variables at block 814 (e.g., accessible across the shared pool), a set of global temporary tables at block 815 (e.g., a current table for only a current session with extensive availability), a set of properties at block 816 (e.g., parameter values, processor usage allocations, memory usage allocations), and a set of configurations at block 817 (e.g., overall processing capability, overall memory capability). As an example, a bank may submit a transaction request which includes a set of command data to order a list of transactions by a specific account holder from most recent to oldest. The set of command data may include a set of session resources, which may be configured to include various information/data. As an example, the set of session resources may include a set of properties which only allow for ten seconds of processing time to process the transaction request. The set of session resources may include a set of client device information (e.g., password/security information with respect to the bank account(s) of the specific account holder). Other examples of configuring a set of session resources may also be possible.

In embodiments, the transaction request may include a write request at block 819. The transaction request can include a write request (e.g., new data inputs, deletion of data). Accordingly, aspects described herein may operate subsequent to performing at least a portion of the write request on a first asset. As an example, a transaction request in a retail store may be received by a database driver. The retail transaction request may have been modified by an employee. The modification may include new data inputs (e.g., items purchased, metadata such as date/time/location, total cost). The modification may include deletion of data (e.g., a transaction which was cancelled). Other examples of a transaction request including a write request may also be possible. At block 820, an updated set of global property data for the database driver may be detected. At block 830, the updated set of global property data for the database driver may be captured. The capturing may occur in a memory device coupled with the database driver.

In embodiments, a first member asset may occur at block 841. The transaction request may be connected with a first member asset of the shared pool of configurable computing resources. Connecting can include linking, associating, calling, pinging, uploading, downloading, establishing a data transfer pipeline, configuring a transmission protocol, or the like. A cloud manager may have selected the first asset according to a predefined algorithm. The first asset may include a first physical compute node (or group of compute nodes), a first virtual machine (or group of virtual machines), or the like. The connecting may occur to process the transaction request. An error event related to the first member asset of the shared pool of configurable computing resources may be detected. Detecting can include recognizing, discovering, sensing, or identifying the error event. For example, the first asset may have failed or may include an (potential/forecasted) error indicator (e.g., a first compute node is unresponsive or went offline such as due to power loss, a memory element of a memory device has been flagged as not working properly, a processor core is at risk of failure due to overheating). The database driver may perform the detection via various monitoring methodologies (e.g., pinging the first asset, subscription to a publication of the cloud manager which indicates status of assets of the shared pool).

It may be ascertained that the error event indicates a configuration for the ACR operation. Ascertaining can include determining, identifying, resolving, evaluating, or performing a comparison. The ascertainment may be based on an error code with respect to the error event. The error code may be looked-up in an error code table. The error code table may indicate whether the error event is eligible for an ACR operation (e.g., the ACR operation may succeed at least a threshold percentage of the time). The ACR operation can provide failover support when a data server client loses connectivity to a first asset (e.g., a primary server for a database). ACR may enable the data server client to recover from a failure by attempting to reconnect to the database through a second asset (e.g., an alternate server for the database). For example, an error may only correspond with the first asset; as such, the configuration may be in place to perform the ACR operation to reroute the transaction request (or at least a portion of the set of command data) to another asset (e.g., the second asset) of the shared pool of configurable computing resources or the like. As an example, a healthcare center may enter a transaction request to search for the medical records of a specific patient. The transaction request may be connected with the first member asset. The first member asset may be flagged due to an overheating error. The error event related to the first member asset may be detected. The error event may match an error code (e.g., ERROR 411: Overheat). The code may be matched to a cell in an error code table. The first member asset may cause overheating in three seconds, which may exceed a threshold length of time for overheating (e.g., average length of time until overheating is twelve seconds). The error event may be deemed eligible for an ACR operation. The transaction request may be rerouted to a second asset for processing. The healthcare professional may be provided with the medical records of the specific patient. Other examples of an error event related to a first member asset may also be possible.

At block 850, an operational member asset of the shared pool of configurable computing resources may be determined. The determining may occur based on the updated set of global property data for the database driver. The determining may occur related to an ACR operation. The determining may occur to process the transaction request. At block 870, the transaction request may be connected with the operational member asset of the shared pool of configurable computing resources. The connecting may occur using the ACR operation. The connecting may occur to process the transaction request. At block 890, the set of command data may be transmitted for the transaction request. The set of command data may be transmitted to the operational member asset of the shared pool of configurable computing resources. The transmitting may occur to process the transaction request.

In embodiments, a failure related to the operational member asset of the shared pool of configurable computing resources may be detected at block 897. Detecting can include monitoring, recognizing, discerning, or discovering a failure. The detection may be similar to the detecting the error event related to the first member asset as described herein. It may be ascertained that the failure indicates an ineligibility for the ACR operation. The indication can include a nature (e.g., corresponding to an error event code) of the ineligibility. An error notification may be returned. The error notification may be returned, delivered, presented, or otherwise provided (e.g., to a user, to the application which originated the transaction request). As an example, an insurance company may submit a transaction request to create a table of rates for all family members under a specific policy. A first member (m1) may experience an error with respect to processing the transaction request. The transaction request may be rerouted to an operational member asset (m2) for processing. Operational member asset m2 may also experience an error with respect to processing the transaction request. The error code may be compared to an error table (ERROR 411: Overheat as described herein). The member asset may take forty seconds to overheat, which does not exceed the threshold of twelve seconds until overheating. The failure indicates an ineligibility for the ACR operation and an error notification (e.g., “ERROR 411: Overheat”, beeping sound, pop-up window) may be presented to the insurance agent. Other examples of a failure related to the operational member asset may also be possible.

Method 800 concludes at block 899. Aspects of method 800 may provide performance or efficiency benefits related to using a database driver to manage application resiliency. Aspects may save resources such as bandwidth, processing, or memory. As an example, aspects may have positive impacts with respect to a rate or quantity of successful transaction requests without burdening the application which originated the transaction request(s). Altogether, performance or efficiency benefits may occur when using a database driver to manage application resiliency with respect to a shared pool of configurable computing resources.

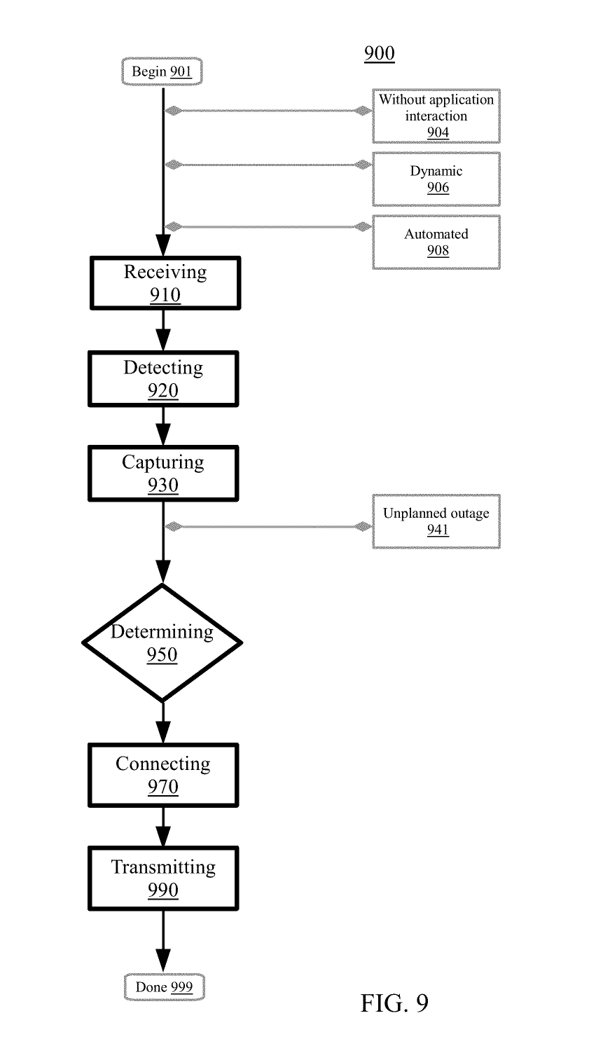

FIG. 9 is a flowchart illustrating a method 900 of using a database driver to manage application resiliency with respect to a shared pool of configurable computing resources. Aspects may be similar or the same as aspects of method 600/700/800, and aspects may be utilized interchangeably with one or more methodologies described herein. The method 900 may begin at block 901.

In embodiments, the receiving, the detecting, the capturing, the determining, the connecting, the transmitting, and the other steps described herein may each be executed without interaction with an application which sent the transaction request at block 904. The steps described herein may occur using (only) the database driver enhancement without requiring support from the database server or the user application. As an example, the transaction request may be rerouted or resubmitted without the knowledge of the user who originally submitted the transaction request. The database driver alone may be sufficient to execute the steps described herein.

In embodiments, the receiving, the detecting, the capturing, the determining, the connecting, the transmitting, and the other steps described herein may each be executed in a dynamic fashion at block 906. The executing may occur in a dynamic fashion to streamline using the database driver to manage application resiliency with respect to the shared pool of configurable computing resources. The set of operational steps may occur in real-time, ongoing, or on-the-fly. As an example, one or more operational steps described herein may be carried-out in an ongoing basis to facilitate, promote, or enhance application resiliency. Other examples may also be possible.

In embodiments, the receiving, the detecting, the capturing, the determining, the connecting, the transmitting, and the other steps described herein may each be executed in an automated fashion at block 908. The executing may occur in an automated fashion without user intervention. The operational steps may each occur in an automated fashion without user intervention or manual action (e.g., using automated computer machinery, fully machine-driven without manual stimuli). The automated operational steps may be performed by an application resiliency management engine (e.g., as part of a data management system), a cloud management engine (e.g., as part of a cloud environment), or the like.

At block 910, a transaction request may be received. The transaction request may have a set of command data. At block 920, an updated set of global property data for the database driver may be detected. At block 930, the updated set of global property data for the database driver may be captured. The capturing may occur in a memory device coupled with the database driver.

In embodiments, an unplanned outage may occur at block 941. An unplanned outage of a set of member assets of the shared pool of configurable computing resources may be sensed. Generally, sensing can include detecting, discovering, recognizing, identifying, or ascertaining an unplanned outage. The unplanned outage may include a loss of power to a group of computing devices. As a result, administrators may desire to add a new computing device to the reroute transaction request. The sensing may occur when carrying-out the transaction request of a source application. An entry for the operational member asset may be added to the updated set of global property data for the database driver. During application execution for an unplanned outage, some members in the affinity list may not respond. There may be a need/desire to add new target cluster members in the ordered list to seamlessly reroute the client transaction request to new target members. Performance of the transaction request may be carried-out. Carrying-out can include processing, resolving, executing, or performing the transaction request. The carrying-out may occur without interaction with the source application. The carrying-out may occur in both a dynamic fashion and a resilient fashion.

Consider the following example. A retail store may submit a transaction request to create a table displaying daily profit by hour. An unplanned outage of a set of member assets may occur. Ordered list members m1, m2, and m3 may not be sufficient to process the transaction request and may cause an outage. An entry for the operational member asset may be added to the updated set of global property data by an administrator. The administrator may add an entry m7 for the operational member asset to the updated set of global property data. Performance of the transaction request may be carried-out by rerouting the transaction request to m7 for processing. The carrying-out may occur without interaction from the source application. The carrying-out may occur seamlessly and may not be noticed by the retail store worker that submitted the transaction request. Other examples of adding an entry to the operational member asset due to an unplanned outage may also be possible.

At block 950, an operational member asset of the shared pool of configurable computing resources may be determined. The determining may occur based on the updated set of global property data for the database driver. The determining may occur related to an ACR operation. The determining may occur to process the transaction request. At block 970, the transaction request may be connected with the operational member asset of the shared pool of configurable computing resources. The connecting may occur using the ACR operation. The connecting may occur to process the transaction request. At block 990, the set of command data may be transmitted for the transaction request. The set of command data may be transmitted to the operational member asset of the shared pool of configurable computing resources. The transmitting may occur to process the transaction request. Method 900 concludes at block 999. Aspects of method 900 may provide performance or efficiency benefits related to using a database driver to manage application resiliency. Aspects may save resources such as bandwidth, processing, or memory. As an example, processing time may be saved by dynamically carrying-out performance of a transaction request during an unplanned outage. The transaction request may be dynamically carried-out without interaction with the source application, which may save processing time. Other methods of saving processing time using application resiliency management may also be possible.

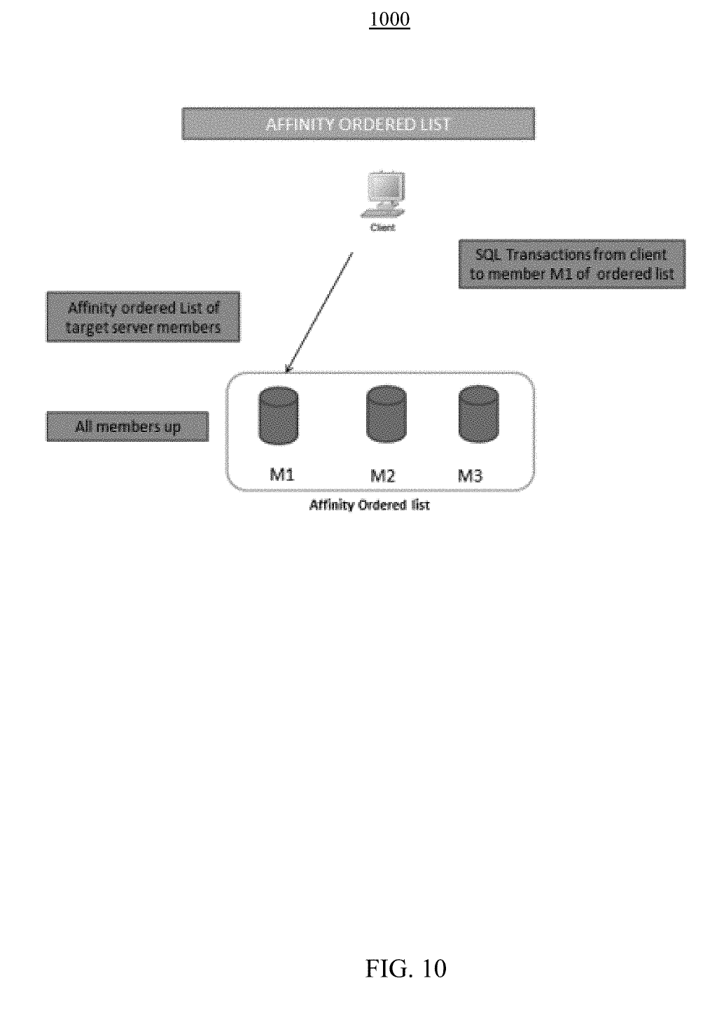

FIG. 10 is an example system 1000 for using a database driver to manage application resiliency. A transaction request may be received by a database driver. An ordered affinity list of a target server may include three members (m1, m2, m3). The SQL statements with session resources from the application may route the transaction request to the first member of the ordered list (m1) via ACR algorithm at the database driver layer. The member m1 may be sufficient to process and route the transaction request. Other examples of using a member (such as m1) to process the transaction request may also be possible.

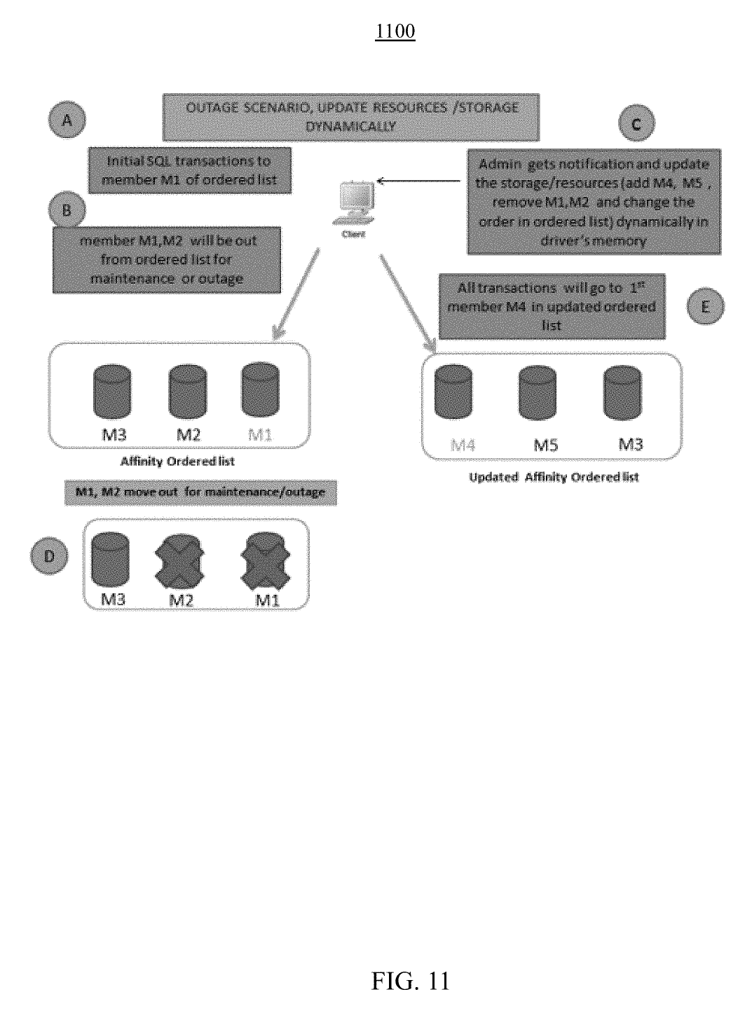

FIG. 11 is an example system 1100 for using a database driver to manage application resiliency. During the application execution, the transaction request may be transmitted to the first member of the ordered list (m1, as described herein). In certain embodiments, the database administrator may detect a need/desire for maintenance/modification of the current member (where the transaction request is being routed, m1). In certain embodiments, an outage may occur (e.g., network outage, site failure, server failure) with respect to the current member (where the transaction request is being routed, m1). The administrator may update the storage/resources of the database driver (e.g., ODBC, JDBC) dynamically without impact the transaction request of the client. The update may include an addition of new members (e.g., m4, m5) to process the request. The update may include a removal of current members (e.g., m1 and m2) to process the request. The update may include rearranging the members of the ordered list (e.g., rearranging from m1, m2, m3 to m3, m2, m1). The update may include any combination of addition of members, removal of members, and rearranging of members. The new ordered list may be updated to the memory of the database driver. The outdated member(s) may be removed from the shared pool of configurable computing resources. The transaction request may failover to the updated ordered list via ACR algorithm in the database driver. Other examples of modifying the members of an ordered list to process a transaction request may also be possible.

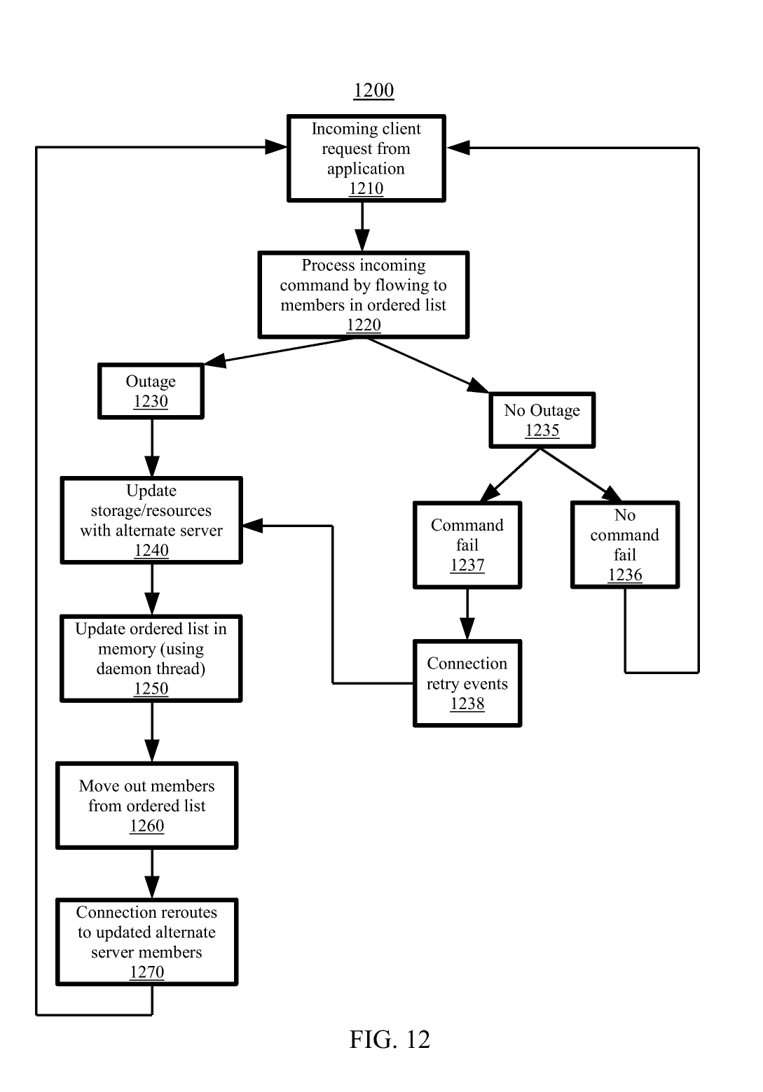

FIG. 12 is an example system 1200 for using a database driver to manage application resiliency. At block 1210, an incoming client request for an SQL or session command from an application may be received by the database driver. At block 1220, a request for SQL transactions or session command or resources from the client may be processed by members of the target server in an ordered list of client affinity. The SQL transactions with session resources may include [Thread:Thread-14][DB2XADataSource@d6f38113]getXAConnection (admf001, <escaped>) called, [Thread:Thread-14][com.ibm.db2.jcc.t4.T4XAConnection@dd73b1cb], [Thread:Thread-14][Connection@dd73b1cb]createStatement ( ) returned Statement@d5f8db26, [Thread:Thread-14][Connection@dd73b1cb]setClientInfo (ClientHostname, sjwkstn1), [Thread:Thread-14][Statement@d5f8db26]executeQuery (SELECT count(*) from sysibm.sysdummy1), or the like. In various embodiments, the database administrator may request maintenance of the current member (e.g., the member in the ordered list which is currently processing the transaction) or an outage may occur at block 1230. At block 1240, the administrator may update the global storage/resources of the database driver dynamically without an impact on the transaction request of the client. This may include removing the cluster member from the ordered list, adding a new cluster member to the ordered list, changing the order of the cluster members in the ordered list, or the like. At block 1250, the database driver may run a daemon thread to check (in a regular interval of time or in response to an event) for an update in the global storage/resources. If there is an update, the database driver may update the ordered list in the memory of the database driver. At block 1260, the specified members (e.g., specified by the administrator) may be removed from the ordered list. At block 1270, the database driver may reroute/failover the connections to the updated members in the ordered list. The SQL requests with session resources may re-execute and continue with the new request of SQL transactions or session commands from the client application.

In various embodiments, maintenance or an outage may not occur at block 1235. In certain embodiments, an ACR eligible error may not occur at block 1236. The database driver may continue with the new request of SQL transactions or session command from the client application (e.g., return to block 1210). In certain embodiments, an ACR eligible error may occur at block 1237. The driver may attempt to reroute the connections to available members (alternate servers) in the ordered list. A notification event may be generated to the database administrator. The administrator may update the global file with new alternate server members in an ordered list (e.g., return to block 1240). Other examples of using a database driver to manage application resiliency with respect to a shared pool of configurable computing resources may also occur.

In addition to embodiments described above, other embodiments having fewer operational steps, more operational steps, or different operational steps are contemplated. Also, some embodiments may perform some or all of the above operational steps in a different order. The modules are listed and described illustratively according to an embodiment and are not meant to indicate necessity of a particular module or exclusivity of other potential modules (or functions/purposes as applied to a specific module).

In the foregoing, reference is made to various embodiments. It should be understood, however, that this disclosure is not limited to the specifically described embodiments. Instead, any combination of the described features and elements, whether related to different embodiments or not, is contemplated to implement and practice this disclosure. Many modifications and variations may be apparent to those of ordinary skill in the art without departing from the scope and spirit of the described embodiments. Furthermore, although embodiments of this disclosure may achieve advantages over other possible solutions or over the prior art, whether or not a particular advantage is achieved by a given embodiment is not limiting of this disclosure. Thus, the described aspects, features, embodiments, and advantages are merely illustrative and are not considered elements or limitations of the appended claims except where explicitly recited in a claim(s).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Embodiments according to this disclosure may be provided to end-users through a cloud-computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud-computing resources are provided to a user on a pay-per-use basis, where users are charged only for the computing resources actually used (e.g., an amount of storage space used by a user or a number of virtualized systems instantiated by the user). A user can access any of the resources that reside in the cloud at any time, and from anywhere across the Internet. In context of the present disclosure, a user may access applications or related data available in the cloud. For example, the nodes used to create a stream computing application may be virtual machines hosted by a cloud service provider. Doing so allows a user to access this information from any computing system attached to a network connected to the cloud (e.g., the Internet).

Embodiments of the present disclosure may also be delivered as part of a service engagement with a client corporation, nonprofit organization, government entity, internal organizational structure, or the like. These embodiments may include configuring a computer system to perform, and deploying software, hardware, and web services that implement, some or all of the methods described herein. These embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to exemplary embodiments, other and further embodiments of the invention may be devised without departing from the basic scope thereof, and the scope thereof is determined by the claims that follow. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. “Set of,” “group of,” “bunch of,” etc. are intended to include one or more. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. The terminology used herein was chosen to explain the principles of the embodiments, the practical application or technical improvement over technologies found in the marketplace, or to enable others of ordinary skill in the art to understand the embodiments disclosed herein.

1. A computer-implemented of using a database driver to manage application resiliency with respect to a shared pool of configurable computing resources, the method comprising:
receiving a transaction request having a set of command data;
detecting an updated set of global property data for the database driver;
capturing, in a memory device coupled with the database driver, the updated set of global property data for the database driver;
determining, based on the updated set of global property data for the database driver and related to an automatic client reroute (ACR) operation, an operational member asset of the shared pool of configurable computing resources to process the transaction request;
connecting, using the ACR operation, the transaction request with the operational member asset of the shared pool of configurable computing resources to process the transaction request; and
transmitting, to the operational member asset of the shared pool of configurable computing resources to process the transaction request, the set of command data for the transaction request.

2. The method of claim 1, further comprising:
receiving, from a user, an updated global property file which includes the updated set of global property data for the database driver.

3. The method of claim 1, further comprising:
modifying, to establish the updated set of global property data for the database driver, an outdated set of global property data in a dynamic fashion.

4. The method of claim 3, further comprising:
removing, from an ordered data structure, a first cluster member entry for a first cluster member;
adding, to the ordered data structure, a second cluster member entry for a second cluster member; and
changing an order of cluster members entries in the ordered data structure which includes:
rearranging, in the ordered data structure to establish the updated set of global property data for the database driver, a third cluster member entry for a third cluster member to be subsequent to a fourth cluster member entry for a fourth cluster member, wherein the outdated set of global property data had the fourth cluster member entry for the fourth cluster member subsequent to the third cluster member entry for the third cluster member.

5. The method of claim 1, further comprising:
monitoring, by the database driver, a global property file for an indication of the updated set of global property data for the database driver.

6. The method of claim 5, further comprising:
running a daemon thread to monitor the global property file, wherein the daemon thread checks for the indication of the updated set of global property data for the database driver on a temporally-periodic basis.

7. The method of claim 5, further comprising:
running a daemon thread to monitor the global property file, wherein the daemon thread checks for the indication of the updated set of global property data for the database driver on an event-based basis.

8. The method of claim 1, further comprising:
connecting the transaction request with a first member asset of the shared pool of configurable computing resources to process the transaction request;
detecting an error event related to the first member asset of the shared pool of configurable computing resources; and
ascertaining that the error event indicates a configuration for the ACR operation.

9. The method of claim 1, further comprising:
deploying, at a first physical location which differs from a set of locations having the shared pool of configurable computing resources, the memory device coupled with the database driver.

10. The method of claim 1, further comprising:
configuring the set of command data to include both:
a set of Structured Query Language (SQL) statements, and
a set of session resources.

11. The method of claim 10, further comprising:
configuring the set of session resources to include:
a set of special registers,
a set of client device information,
a set of global variables,
a set of global temporary tables,
a set of properties, and
a set of configurations.

12. The method of claim 1, further comprising:
receiving an indication to use the database driver to manage application resiliency, wherein the indication to use the database driver to manage application resiliency is without a set of application-originated code to handle an error event.

12. (canceled)

13. The method of claim 1, further comprising:
detecting a failure related to the operational member asset of the shared pool of configurable computing resources;
ascertaining that the failure indicates an ineligibility for the ACR operation; and
returning an error notification.

14. The method of claim 1, further comprising:
sensing, when carrying-out the transaction request of a source application, an unplanned outage of a set of member assets of the shared pool of configurable computing resources;
adding, to the updated set of global property data for the database driver, an entry for the operational member asset; and
carrying-out, without interaction with the source application, performance of the transaction request in both a dynamic fashion and a resilient fashion.

15. The method of claim 1, further comprising:
executing, without interaction with an application which sent the transaction request, each of:
the receiving, the detecting, the capturing, the determining, the connecting, and the transmitting.

16. The method of claim 1, further comprising:
executing, in a dynamic fashion to streamline using the database driver to manage application resiliency with respect to the shared pool of configurable computing resources, each of:
the receiving, the detecting, the capturing, the determining, the connecting, and the transmitting.

17. The method of claim 1, further comprising:
executing, in an automated fashion without user intervention, each of:
the receiving, the detecting, the capturing, the determining, the connecting, and the transmitting.

18. The method of claim 1, wherein the transaction request includes a write request, further comprising:
deploying, at a first physical location which differs from a set of locations having the shared pool of configurable computing resources, the memory device coupled with the database driver;
configuring the set of command data to include both:
a set of Structured Query Language (SQL) statements, and
a set of session resources;
configuring the set of session resources to include:
a set of special registers,
a set of client device information,
a set of global variables,
a set of global temporary tables,
a set of properties, and
a set of configurations;
connecting the write request with a first member asset of the shared pool of configurable computing resources to process the write request;
detecting an error event related to the first member asset of the shared pool of configurable computing resources;
monitoring, by the database driver running a daemon thread, a global property file for an indication of the updated set of global property data for the database driver;
receiving, from a user, an updated global property file which includes the updated set of global property data for the database driver;
modifying, to establish the updated set of global property data for the database driver, an outdated set of global property data in a dynamic fashion;
ascertaining that the error event indicates a configuration for the ACR operation; and
receiving an indication to use the database driver to manage application resiliency, wherein the indication to use the database driver to manage application resiliency is without a set of application-originated code to handle the error event.

19. A system of using a database driver to manage application resiliency with respect to a shared pool of configurable computing resources, the method comprising:
a memory having a set of computer readable computer instructions, and
a processor for executing the set of computer readable instructions, the set of computer readable instructions including:
receiving a transaction request having a set of command data;
detecting an updated set of global property data for the database driver;
capturing, in a memory device coupled with the database driver, the updated set of global property data for the database driver;
determining, based on the updated set of global property data for the database driver and related to an automatic client reroute (ACR) operation, an operational member asset of the shared pool of configurable computing resources to process the transaction request;
connecting, using the ACR operation, the transaction request with the operational member asset of the shared pool of configurable computing resources to process the transaction request; and
transmitting, to the operational member asset of the shared pool of configurable computing resources to process the transaction request, the set of command data for the transaction request.

20. A computer program product of using a database driver to manage application resiliency with respect to a shared pool of configurable computing resources, the computer program product comprising a computer readable storage medium having program instructions embodied therewith, wherein the computer readable storage medium is not a transitory signal per se, the program instructions executable by a processor to cause the processor to perform a method comprising:
receiving a transaction request having a set of command data;
detecting an updated set of global property data for the database driver;
capturing, in a memory device coupled with the database driver, the updated set of global property data for the database driver;
determining, based on the updated set of global property data for the database driver and related to an automatic client reroute (ACR) operation, an operational member asset of the shared pool of configurable computing resources to process the transaction request;
connecting, using the ACR operation, the transaction request with the operational member asset of the shared pool of configurable computing resources to process the transaction request; and
transmitting, to the operational member asset of the shared pool of configurable computing resources to process the transaction request, the set of command data for the transaction request.
